(19) United States
(12) Patent Application Publication
(10) Pub. No.: US 2009/0268678 A1
(43) Pub. Date: Oct. 29, 2009

(54) METHOD AND APPARATUS FOR AUTOMATIC GAIN CONTROL IN A MOBILE ORTHOGONAL FREQUENCY DIVISION MULTIPLE ACCESS (OFDMA) NETWORK

(75) Inventors: Changqin Huo, Calgary (CA); Dorin Viorel, Calgary (CA)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/338,411

(22) Filed: Dec. 18, 2008

Related U.S. Application Data
(60) Provisional application No. 61/047,601, filed on Apr. 24, 2008.
(60) Provisional application No. 61/047,885, filed on Apr. 25, 2008.

(51) Int. Cl. H04W 72/04

(52) U.S. Cl. 370/329

(57) ABSTRACT

A zone/slot-based automatic gain control method for stations operating in a mobile OFDMA network including receiving an uplink signal, converting the received uplink signal into an analog baseband signal, measuring or calculating a signal strength of the received uplink signal in an uplink zone in an uplink subframe, and adjusting a power level of the analog baseband signal in accordance with the measured or calculated signal strength during either the first cyclic prefix of an uplink zone or the first cyclic prefix in each uplink slot of an uplink zone.

### CROSS-REFERENCE TO RELATED APPLICATIONS

The present application claims priority to provisional application titled “ZONE BASED AUTOMATIC GAIN CONTROL (AGC) SCHEMES FOR UL RECEIVERS IN WIMAX SYSTEMS”, Ser. No. 61/047,601, filed Apr. 24, 2008, inventors Changqin Huo and Dorin Viorel, attorney docket number 1974.1024P and provisional application titled “ZONE/SLOT BASED AUTOMATIC GAIN CONTROL (AGC) SCHEMES FOR UL RECEIVERS IN WIMAX SYSTEMS”, Ser. No. 61/047,885, filed Apr. 25, 2008, inventors Changqin Huo and Dorin Viorel, attorney docket number 1974.1025P, which are incorporated herein by reference.

### BACKGROUND OF THE INVENTION

### Description of the Related Art

Wireless communication networks have become increasingly popular and generally include a base station that provides service to a cell area located around the base station. Mobile stations (such as cell phones, etc.) are able to communicate with the base station when they are within the service area of the base station.

However, in wireless communication networks, due to such effects as shadowing arising from blockage by buildings and other obstructions between transmission/reception antennas, there exist dead zones in which communication with the base station is not possible, despite being within the service area. To combat this problem, in an Orthogonal Frequency Division Multiple Access (OFDMA) network, such as, for example, a network based on the Institute of Electrical and Electronics Engineers (IEEE) 802.16 standard, relay stations are employed for providing enhanced transmission capabilities by acting as intermediaries between mobile stations operating in the network and the base station. In this manner, a mobile station that is incapable of connecting directly to a base station within its cell service area may still connect indirectly to the base station by first communicating with a relay station that does have a direct link, or possibly an indirect link, to the base station.

The 802.16j standard is a new addition to the IEEE 802.16 suite of standards, currently being defined, which governs the behavior of a relay station operating within an 802.16e mobile network. This standard is often referred to as a Mobile Relay System (MRS). IEEE 802.16e/j compliant systems are commonly called WiMAX systems.

The IEEE 802.16e system uses Scalable OFDMA to carry data, supporting channel bandwidths of between 1.25 MHz and 28 MHz, with up to 2048 sub-carriers. It supports adaptive modulation and coding schemes (MCS), so that in the case of good channel conditions, a highly efficient 64- or 16-QAM (Quadrature Amplitude Modulation) coding scheme is used, whereas, when the channel conditions are poor, a more robust Quadrature Phase-Shift Keying (QPSK) coding mechanism is used between base stations and mobile stations.

For IEEE 802.16e/j systems, an uplink signal level received at the base station (or relay station) could fluctuate dramatically due to different MCS being used, as well as due to different distances between base stations and mobile stations and between relay stations and mobile stations. According to the IEEE 802.16e standard, a base station should be capable of decoding a maximum on-channel signal of −45 dBm and shall tolerate a maximum signal of −10 dBm without damage. On the other hand, the base station should also be capable of decoding a weak signal just above the sensitivity level, e.g. −100 dBm for CTC-QPSK1/2 (repetition of 6) with a bandwidth of 3.5 MHz.

In order to support a possible signal dynamic range of 55 dB or more, analog-to-digital converters (ADC) with high speed and high dynamic range have been proposed as a possible solution. However, this solution requires a high cost and results in poor performance because ADCs with high speed and a high dynamic range results in a high cost and a low analog power gain at the RF front end (to avoid saturation at the ADCs for strong signals) leads to poor performance for weak signals.

### SUMMARY OF THE INVENTION

Various embodiments of the present invention provide a method including receiving an uplink signal in a mobile Orthogonal Frequency Division Multiple Access (OFDMA) network and converting the received uplink signal into an analog baseband signal. The method further includes measuring a signal strength of the received uplink signal and calculating an average power of a cyclic prefix of a first symbol in an uplink zone in an uplink subframe of the received uplink signal based on the measured signal strength. Finally, the method includes adjusting a power level of the analog baseband signal in accordance with the calculated average power during the cyclic prefix.

Various embodiments of the present invention provide a method including receiving an uplink signal in a mobile Orthogonal Frequency Division Multiple Access (OFDMA) network and converting the received uplink signal into an analog baseband signal. The method further includes measuring a signal strength of the received uplink signal and, if a current slot is the first uplink slot of an uplink zone in an uplink subframe of the received uplink signal, calculating an average power of a cyclic prefix of the first uplink slot or, if a current slot is not the first uplink slot of an uplink zone in an uplink subframe of the received uplink signal, calculating an average power of all of the preceding slots in the uplink zone. Finally, the method includes adjusting a power level of the analog baseband signal in accordance with the calculated average power during the cyclic prefix of the current slot.

Various embodiments of the present invention provide a station operating in a mobile Orthogonal Frequency Division Multiple Access (OFDMA) network including an antenna receiving an uplink signal and an analog block converting the received uplink signal into an analog baseband signal. The station further includes a received signal strength indicator measuring a signal strength of the uplink signal received during either a first cyclic prefix of a first slot in an uplink zone in an uplink subframe of the received uplink signal only or the first cyclic prefix of the first slot in the uplink zone and each of the preceding uplink slots in the uplink zone, if such preceding slots exist, and outputting a digital received signal strength indicator. Also, the station includes an automatic gain controller adjusting a power level of the analog baseband signal in accordance with the digital received signal strength indicator during either a cyclic prefix of a first symbol in an uplink zone in an uplink subframe of the received uplink signal or a first cyclic prefix of each uplink slot of the uplink zone.

Various embodiments of the present invention provide a station operating in a mobile Orthogonal Frequency Division Multiple Access (OFDMA) network including an antenna receiving an uplink signal and an analog block converting the received uplink signal into an analog baseband signal. The station further includes a received signal strength indicator measuring a signal strength of the received uplink signal and outputting an analog received signal strength indication. Also, the station includes an analog-to-digital converter (ADC) digitizing the analog received signal strength indicator and an automatic gain controller adjusting a power level of the analog baseband signal in accordance with the digitized received signal strength indicator during either a first cyclic prefix in an uplink zone in an uplink subframe of the received uplink signal or a first cyclic prefix in each uplink slot in an uplink zone in an uplink subframe of the received uplink signal.

The above embodiments of the present invention are simply examples, and all embodiments of the present invention are not limited to these examples.

Additional advantages of the invention will be set forth in part in the description which follows, and, in part, will be obvious from the description, or may be learned by practice of the invention.

### BRIEF DESCRIPTION OF THE DRAWINGS

These and other objects and advantages of the invention will become apparent and more readily appreciated from the following description of the preferred embodiments, taken in conjunction with the accompanying drawings of which:

FIG. 1 is an illustration of an example of a frame structure of a signal in an Orthogonal Frequency Division Multiple Access (OFDMA) network.

FIG. 2 is an illustration of an example of a frame structure of a signal in an Orthogonal Frequency Division Multiple Access (OFDMA) network.

FIG. 3 is an illustration of a receiver for carrying out an automatic gain control method according to an embodiment of the present invention.

FIG. 4 is an illustration of a receiver for carrying out an automatic gain control method according to an embodiment of the present invention.

FIG. 5 is a graph illustrating an automatic gain control method according to an embodiment of the present invention.

FIG. 6 is a graph illustrating an automatic gain control method according to an embodiment of the present invention.

FIG. 7 is an illustration of a cyclic prefix according to an embodiment of the present invention.

### DETAILED DESCRIPTION OF THE PREFERRED EMBODIMENTS

Reference will now be made in detail to the present preferred embodiments of the present invention, examples of which are illustrated in the accompanying drawings, wherein like reference numerals refer to like elements throughout.

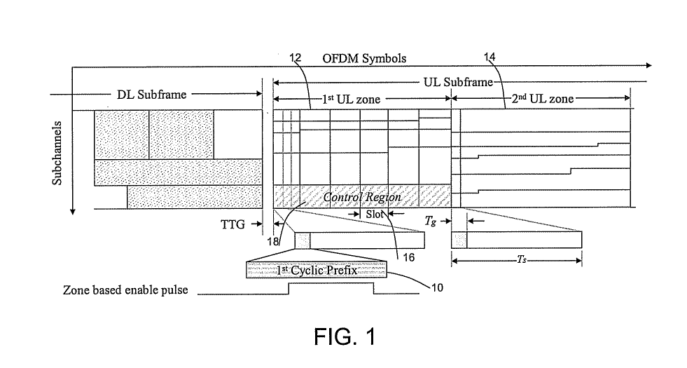

FIG. 1 is an illustrative example of a frame structure of a signal in an Orthogonal Frequency Division Multiple Access (OFDMA) network. For example, the OFDMA network can be a mobile OFDMA network based on one of the Institute of Electrical and Electronics Engineers (IEEE) 802.16 standards. However, the various embodiments of the present invention are not limited to an OFDMA network being a mobile OFDMA network based on one of the IEEE 802.16 standards, but can be any type of OFDMA network.

In an OFDMA system, transmission takes place in a unit of symbols. During an uplink subframe, transmission time is referred to with respect to the start and end time of an OFDM symbol reception window operated by a base station or relay station. This reception window includes all of the signals sent by a transmitter (slave station) corresponding to an OFDM symbol as they are sampled at the receiver (master station).

According to various embodiments of the present invention, a set of automatic gain control (AGC) schemes adjust the power gain of the analog signal chain from the antenna ports of a receiver (for example, a receiver associated with a base station or a relay station) in a mobile OFDMA network to the analog-to-digital converter (ADC) inputs of the receiver automatically, without affecting the signal processing at the digital baseband. Referring to FIG. 1, according to one such scheme, the average power of the first cyclic prefix (CP) 10 of each uplink zone is used. Uplink zones, such as the first uplink zone 12 and the second uplink zone 14, represent a time period in which the receiver can receive uplink signals from a master station operating within a common cell in the mobile OFDMA network.

According to the 802.16e standard, the uplink subchannel allocations are performed in a time-first manner. More specifically, the subchannels are allocated to burst at the first available subchannel of the first available symbol, and are then allocated continually such that the OFDM symbol index is increased. When the edge of the first uplink zone 12 is reached, the subchannels will be allocated from the lowest numbered OFDM symbol available in the next subchannel. In this way, the average power of the first symbol of each uplink zone is close to the average power of that UL zone. Furthermore, the CP of each symbol is actually the same as the rear part of the useful symbol in IEEE 802.16e/j systems. Therefore, according to various embodiments of the present invention, the average power of the CP 10 can be used to represent the average power of the whole uplink zone 12 for the purpose of adjusting the power gain of the analog chain such that the signal level at the input of an ADC is within an acceptable range. More specifically, the various embodiments of the present invention provide for expanding the dynamic range of the base station and relay station receivers beyond values of 63 dB.

On a smaller level, the average power of the previous slots of a current zone can be used to further improve the AGC performance for a slot-based AGC scheme according to various embodiments of the present invention. Typically, a slot 16 is composed of 3 OFDM symbols in an uplink subframe in IEEE 802.16e/j systems. Thus, in order to improve the AGC performance on fast fading channels, the estimated average power of the previous slots of the current zone is further used for the purpose of adjusting the power gain of the analog chain such that the signal level at the input of an ADC is within an acceptable range for the ADC. Of course, different ADCs might have different acceptable ranges and the various embodiments of the present invention are not limited to any particular ADC.

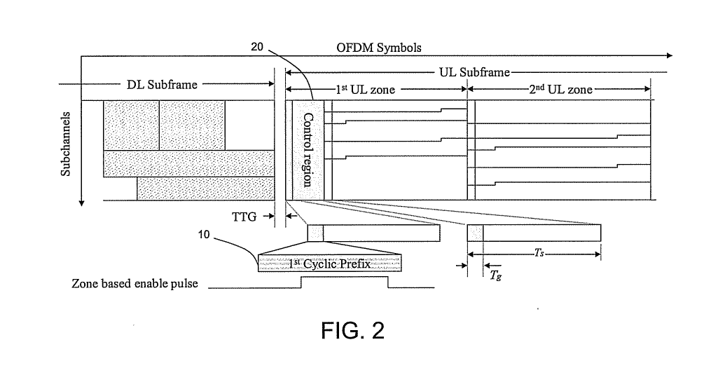

Of course, in mobile OFDMA networks, there are some control regions (such as ranging regions and fast feedback regions) that do not follow the time-first allocation rule in the uplink subchannel allocations. However, the impact of these regions can be mitigated by properly scheduling of these regions in the related uplink zone by the respective base station or relay station. The control region allocation example (control region 18) shown in FIG. 1 is one of the possible solutions. Of course, when the control region 20 is scheduled as a stand-alone area as shown in FIG. 2, the stand-alone area can be treated as a special “zone”. In this case, another AGC cycle is required for the rest of the zone. A solution for this case is to set a fixed analog block gain according to target power received at this area.

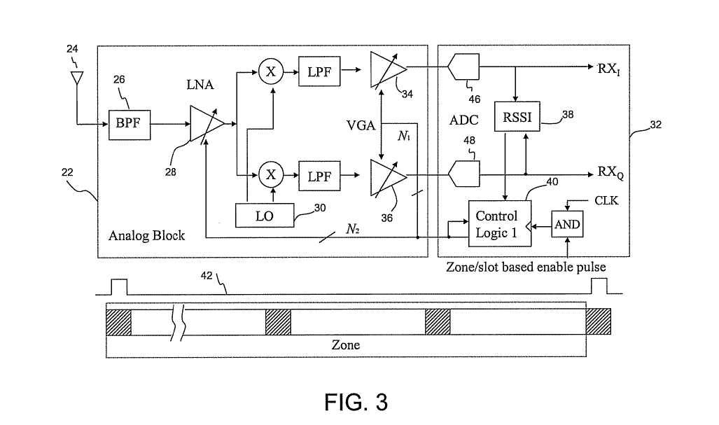

In FIG. 3, the structural architecture of a receiver (associated with a base station or relay station, for example) implementing the AGC schemes according to various embodiments of the present invention is illustrated. In FIG. 3, an uplink signal is received at antenna 24 connected to an analog block 22 of the receiver. A band pass filter 26 (BPF) is used to depress the unwanted out-of-band noises of the received uplink signal. Thereafter, a low noise amplifier 28 (LNA) helps to amplify the received uplink signal and controls the noise figure in the analog chain. RF chips may provide the LNA 28 with several selectable gains. The local oscillator 30 (LO) provides a local carrier tone to down-convert the radio frequency (RF) signal to a baseband or intermediate frequency (IF) signal. Thereafter, the analog-to-digital converters 46 and 48 (ADCs) convert the analog signals into digital signals.

A variable gain amplifier method is provided for implementing the AGC schemes according to various embodiments of the present invention. In the example of FIG. 3, two amplifiers (VGAs) 34 and 36 are included. These amplifiers 34 and 36 adjust the gain (attenuation) value of the baseband analog signal output from the analog block 22 according to the digital (analog) control inputs, so that the signal level at the ADC inputs is within an acceptable range for the ADC. As discussed above, for zone-based AGC, an average power of a cyclic prefix of a first symbol in an uplink zone in an uplink subframe of the mobile OFDMA network is determined and a power gain of the amplifiers 34 and 36 is adjusted in accordance with the determined average power during that cyclic prefix, such that the analog baseband signal output to the ADC is within an acceptable range for the ADC.

For slot-based AGC, an average power of the cyclic prefix of the first symbol for the first slot or an average power of the preceding slots, for each non-first slot, in an uplink zone is determined, and a power gain of the amplifiers 34 and 36 is adjusted in accordance with the determined average power during the first cyclic prefix of the corresponding slot such that the analog baseband signal output to the ADC is within an acceptable range for the ADC.

As seen in FIG. 3, the analog baseband signal that is adjusted in accordance with various embodiments of the present invention can include both an in-phase signal of the received uplink signal and a quadrature signal of the received uplink signal. As such, the adjusting of the baseband signal in accordance with the determined average power of the CP of the first symbol in an uplink zone in the uplink subframe of the mobile OFDMA network can be carried out on one or both of the in-phase signal and the quadrature signal. This is the case for both the zone-based AGC scheme and the slot-based AGC scheme discussed above.

In the embodiment illustrated in FIG. 3, an AGC scheme is carried out based on a signal strength obtained at the received signal strength indicator unit 38 (RSSI). In an IEEE 802.16 system, an RSSI value is the received signal strength in a wireless environment, in arbitrary units. For the receiver of FIG. 3, the RSSI unit 38 is provided after the ADCs 46 and 48. Therefore, the RSSI values are derived based on the output of the ADCs 46 and 48 and can be computed by using the following equation:

RSSI(k)=(1−α) RSSI(k−1)+α(RX_{I}(k)²+RX_{Q}(k)²),

where RSSI(k) is the RSSI corresponding to OFDM sample k, α is a variable that can be used to update RSSI(k), and RX_{I}(k)²+RX_{Q}(k)² denotes the instantaneous received signal strength of OFDM sample k.

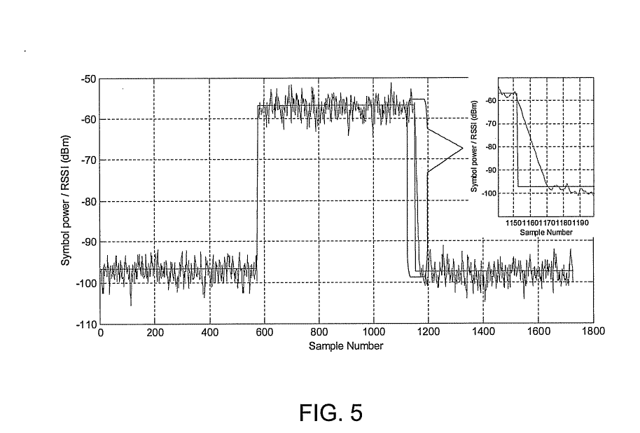

The variable α is chosen based on the OFDM fast Fourier transform (FFT) size used in the network system. The smaller the value of a in the above equation, the less RSSI fluctuation, whereas a larger value of a requires a smaller number of OFDM samples for RSSI convergence when the signal power decreases suddenly. For a slot-based AGC scheme according to various embodiments of the present invention, the above equation can be used to estimate the average power of the previous slots of the current uplink zone, such that the amount of memory required can be reduced. The RSSI estimation performance for the above equation is shown in FIG. 5 under a condition in which the variable a has a value of 0.4 and the FFT size is 512. In FIG. 5, it can be seen that this equation (solution) provides an acceptable performance for the purpose of automatic gain control.

For the receiver of FIG. 3, the RSSI unit 38 is provided after the ADCs 46 and 48. Therefore, the RSSI values are derived based on the output of the ADCs 46 and 48 and can also be computed by using the following equation:

$$R S S I ( k ) = {\sum }_{i = k - K + 1}^{k} ( {{RX}_{I} ( i )}^{2} + {{RX}_{Q} ( i )}^{2} ) / K ,$$

where RSSI(k) is the RSSI corresponding to OFDM sample k, K is the window length, and RX_{I}(i)²+RX_{Q}(i)² denotes the instantaneous received signal strength of OFDM sample i.

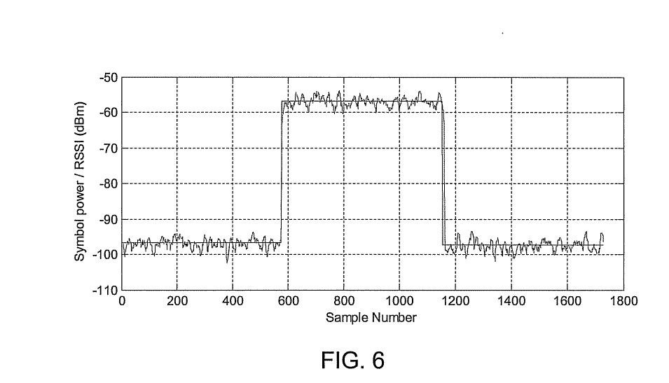

The window length K is chosen based on the OFDM fast Fourier transform (FFT) size used in the network system. The larger the value of K in the above equation, the less RSSI fluctuation, whereas a larger value of K requires a larger number of OFDM samples for RSSI convergence when the signal power decreases suddenly. The RSSI estimation performance for the above equation is shown in FIG. 6 under a condition in which the window length K has a value of 10 and the FFT size is 512. In FIG. 6, it can be seen that this equation (solution) provides an acceptable performance for the purpose of automatic gain control.

Referring again to FIG. 3, the digital baseband block 32 also includes a control logic unit 40 that provides a mapping from its inputs (for example, the digital RSSI from the RSSI unit 38 and the whole or part of the old VGA gain control output) to the new VGA gain control output. This mapping may be implemented using a configurable lookup table (LUT) or other methods. Usually, N₁, the number of control bits to the VGA (amplifiers 34 and 36) is around 7. The number of bits N₂ output to the LNA 28 is variable and can be used to further increase the dynamic range, when necessary. If the VGA in the analog block only accepts an analog input, a digital-to-analog converter can be used to change the control information from a digital format to an analog format.

When the zone/slot based enable pulse 42 goes logic high, the rising edges of the VGA gain update clock CLK will trigger control logic unit 40 to update the VGA gain control output of the control logic unit 40. For zone-based AGC, at least one pulse is required for each zone, whereas, for slot based AGC, at least one enable pulse is provided for each slot. The zone-based enable pulse and the VGA gain update clock CLK can be designed based on the FFT size used in the network system, the converting delay of the ADCs 46 and 48, and the RSSI implementation methods and parameters.

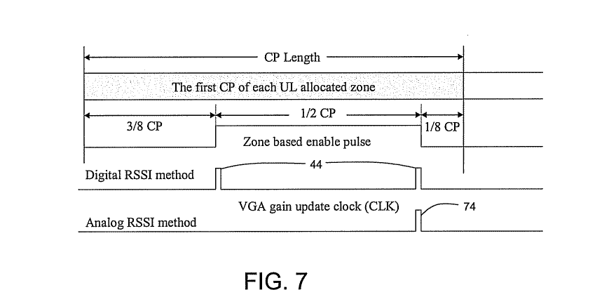

One example of the zone based enable pulse and the VGA gain update clock CLK is shown in FIG. 7, in which the first three-eighths (⅜) of the CP length is utilized for the RSSI preparation. For the AGC method provided by the receiver of FIG. 3, two VGA gain update clock pulses 44 will pass the “AND” logic so that the VGA gains can be updated twice within the first CP of each uplink zone, which will improve the AGC performance when saturation happens due to a strong initial signal inputs of the ADCs 46 and 48. The last one-eighth (⅛) of the CP length is utilized to settle the gain value of VGAs 34 and 36. In the slot-based AGC scheme, the VGA gain is required to be updated only once per slot, except during the first CP of each uplink zone.

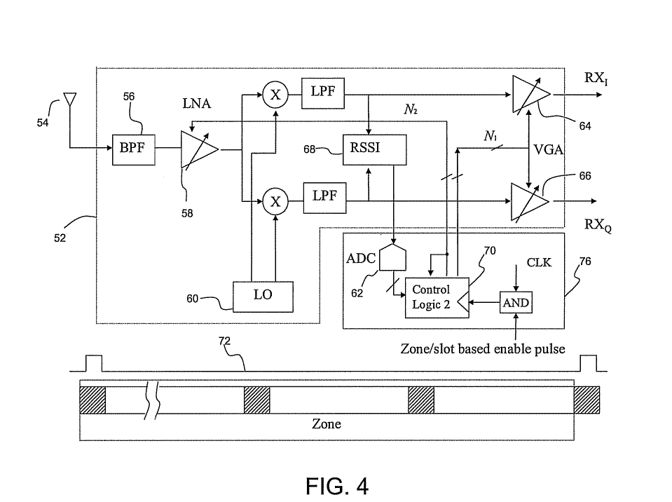

In FIG. 4, the structural architecture of a receiver (associated with a base station or relay station, for example) implementing the AGC schemes according to various embodiments of the present invention is illustrated. In FIG. 4, an uplink signal is received at antenna 54 connected to an analog block 52 of the receiver. A band pass filter 56 (BPF) is used to depress the unwanted out-of-band noises of the received uplink signal. Thereafter, a low noise amplifier 58 (LNA) helps to amplify the received uplink signal and controls the noise figure in the analog chain. RF chips may provide the LNA 58 with several selectable gains. The local oscillator 60 (LO) provides a local carrier tone to down-convert the radio frequency (RF) signal to a baseband or intermediate frequency (IF) signal.

A variable gain amplifier method is provided for implementing the AGC schemes according to various embodiments of the present invention. In the example of FIG. 4, two amplifiers (VGAs) 64 and 66 are used. These amplifiers 64 and 66 adjust the gain (attenuation) value of the baseband analog signal output from the analog block 52 according to the digital (analog) control inputs, so that the signal level at the inputs of the ADC (not shown in FIG. 4) is within an acceptable range for that particular ADC. As discussed above, for zone-based AGC, an average power of the of a cyclic prefix of a first symbol in an uplink zone in an uplink subframe of the mobile OFDMA network is determined and a power gain of the amplifiers 64 and 66 is adjusted in accordance with the determined average power such that the analog baseband signal output to the ADC is within an acceptable range for the ADC.

For slot-based AGC, an average power of the cyclic prefix of the first symbol for the first slot or an average power of the preceding slots, for each non-first slot, in an uplink zone is determined, and a power gain of the amplifiers 64 and 66 is adjusted in accordance with the determined average power during the first cyclic prefix of the corresponding slot such that the analog baseband signal output to the ADC is within an acceptable range for the ADC.

For the receiver of FIG. 4, the RSSI unit 68 is included in the analog block 52 and, therefore, the RSSI values are derived at the analog block 52 before the analog baseband signal is output to the ADC (not shown in FIG. 4).

Referring still to FIG. 4, an ADC 62 is included in the control block 76 when the RSSI provided by the analog block 52 is in an analog format and the ADC digitized the analog RSSI. The control block 76 also includes a control logic unit 70 that provides a mapping from its inputs (for example, the digitized RSSI from the RSSI unit 68 and the whole or part of the old VGA gain control output) to the new VGA gain control output. This mapping may be implemented using a configurable lookup table (LUT) or other methods. Usually, N₁, the number of control bits to the VGA (amplifiers 64 and 66) is around 7. The number of bits N₂ output to the LNA 58 is variable and can be used to further increase the dynamic range, when necessary. If the VGA in the analog block only accepts an analog input, a digital-to-analog converter can be used to change the control information from a digital format to an analog format.

When the zone/slot based enable pulse 72 goes logic high, the rising edges of the VGA gain update clock CLK will trigger control logic unit 70 to update the VGA gain control output of the control logic unit 70. For zone base AGC, one pulse is required for each zone, whereas, for slot based AGC, an enable pulse is provided for each slot. The zone based enable pulse and the VGA gain update clock CLK can be designed based on the FFT size used in the network system, the converting delay of the ADC 62, and the RSSI step response performance.

One example of the zone based enable pulse and the VGA gain update clock CLK is shown in FIG. 7, in which the first three-eighths (⅜) of the CP length is utilized for the RSSI preparation. For the AGC method provided by the receiver of FIG. 4, a single VGA gain update clock pulse 74 will pass the “AND” logic, which will provide a better RSSI estimation accuracy. The last one-eighth (⅛) of the CP length is utilized to settle the gain value of VGAs 64 and 66.

The various embodiments of the present invention provide a set of AGC implementation schemes that update the analog chain gains during the first CP of an uplink zone based on the power measurement of the first CP of the uplink zone, for both zone-based AGC and slot-based AGC, and update the analog chain gains during the first CP of an uplink slot based on the power measurement of the preceding uplink slots, for slot-based AGC for a slot that is not the first slot in an uplink zone. These schemes can effectively increase the dynamic range of the uplink receiver (implemented in a base station and/or relay station, for example) in a WiMAX system without affecting the signal processing in the digital baseband. Furthermore, the various AGC schemes have very low implementation complexity and require the analog block to have only a gain-controllable amplifier.

The present invention relates to a mobile OFDMA network under the IEEE 802.16 standard, which includes its amendments and extensions, such as, for example, but not limited to, IEEE 802.16e and IEEE 802.16j. The IEEE 802.16 standard is incorporated herein by reference in its entirety.

Various configuration examples of an analog block and an analog-to-digital converter are provided herein. However, embodiments of the present invention are not limited to these specific example, and many variations are possible.

Although a few preferred embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A method, comprising:
receiving an uplink signal in a mobile Orthogonal Frequency Division Multiple Access (OFDMA) network;
converting the received uplink signal into an analog baseband signal;
measuring a signal strength of the received uplink signal and calculating an average power of a cyclic prefix of a first symbol in an uplink zone in an uplink subframe of the received uplink signal based on the measured signal strength; and
adjusting a power level of the analog baseband signal in accordance with the calculated average power during the cyclic prefix.

2. A method as in claim 1, wherein the signal strength is a signal strength measured at an orthogonal frequency-division multiplexed (OFDM) sample, and the calculating calculates according to RSSI(k)=(1−α)*RSSI(k−1)+α(RX_{I}(k)²+RX_{Q}(k)²), where RSSI(k) is the signal strength measured at OFDM sample k, α is a variable that can be used to update RSSI(k), RSSI(k−1) is the signal strength measured at OFDM sample k−1, and RX_{I}(k)²+RX_{Q}(k)² is an instantaneous received signal strength of sample k.

3. A method as in claim 1, wherein the signal strength is a signal strength measured at an orthogonal frequency-division multiplexed (OFDM) sample, and the calculating calculates according to
$$R S S I ( k ) = {\sum }_{i = k - K + 1}^{k} ( {{RX}_{I} ( i )}^{2} + {{RX}_{Q} ( i )}^{2} ) / K ,$$
where RSSI(k) is the signal strength measured at OFDM sample k, K is a window length of the first symbol, and RX_{I}(i)²+RX_{Q}(i)² is an instantaneous received signal strength of OFDM sample i.

4. A method as in claim 1, wherein the analog baseband signal is an in-phase signal of the received uplink signal.

5. A method as in claim 1, wherein the analog baseband signal is a quadrature signal of the received uplink signal.

6. A method as in claim 1, wherein the analog baseband signal includes both an in-phase signal and a quadrature signal of the received uplink signal, and the adjusting adjusts a power level of both the in-phase signal and the quadrature signal in accordance with the calculated average power.

7. A method as in claim 1, wherein the analog baseband signal is amplified by an amplifier having a gain, and said adjusting comprises adjusting the power level of the analog baseband signal by adjusting the gain of the amplifier.

8. A method as in claim 1, further comprising setting the calculated average power of the cyclic prefix as an average power of the entire uplink zone.

9. A method, comprising:
receiving an uplink signal in a mobile Orthogonal Frequency Division Multiple Access (OFDMA) network;
converting the received uplink signal into an analog baseband signal;
measuring a signal strength of the received uplink signal and, if a current slot is the first uplink slot of an uplink zone in an uplink subframe of the received uplink signal, calculating an average power of a first cyclic prefix of the first uplink slot or, if a current slot is not the first uplink slot of an uplink zone in an uplink subframe of the received uplink signal, calculating an average power of all of the preceding slots in the uplink zone; and
adjusting a power level of the analog baseband signal in accordance with the calculated average power during the cyclic prefix of the current slot.

10. A method as in claim 9, wherein the signal strength is a signal strength measured at an orthogonal frequency-division multiplexed (OFDM) sample, and the calculating calculates according to RSSI(k)=(1−α)*RSSI(k−1)+α(RX_{I}(k)²+RX_{Q}(k)²), where RSSI(k) is the signal strength measured at OFDM sample k, α is a variable that can be used to update RSSI(k), RSSI(k−1) is the signal strength measured at OFDM sample k−1, and RX_{I}(k)²+RX_{Q}(k)² is an instantaneous received signal strength of sample k.

11. A method as in claim 9, wherein the analog baseband signal is an in-phase signal of the received uplink signal.

12. A method as in claim 9, wherein the analog baseband signal is a quadrature signal of the received uplink signal.

13. A method as in claim 9, wherein the analog baseband signal includes both an in-phase signal and a quadrature signal of the received uplink signal, and the adjusting adjusts a power level of both the in-phase signal and the quadrature signal in accordance with the calculated average power.

14. A method as in claim 9, wherein the analog baseband signal is amplified by an amplifier having a gain, and said adjusting comprises adjusting the power level of the analog baseband signal by adjusting the gain of the amplifier.

15. A method as in claim 9, further comprising setting the calculated average power of the preceding slots, if such preceding slots exist, as an average power of the current slot.

16. A station operating in a mobile Orthogonal Frequency Division Multiple Access (OFDMA) network, comprising:
an antenna receiving an uplink signal;
an analog block converting the received uplink signal into an analog baseband signal;
a received signal strength indicator measuring a signal strength of the uplink signal received during either a first cyclic prefix of a first slot in an uplink zone in an uplink subframe of the received uplink signal only or the first cyclic prefix of the first slot in the uplink zone and each of the preceding uplink slots in the uplink zone, if such preceding slots exist, and outputting a digital received signal strength indicator; and
an automatic gain controller adjusting a power level of the analog baseband signal in accordance with the digital received signal strength indicator during either a cyclic prefix of a first symbol in an uplink zone in an uplink subframe of the received uplink signal or a first cyclic prefix of each uplink slot of the uplink zone.

17. The station as in claim 16, wherein the received signal strength indicator measures a signal strength of the uplink signal received during a cyclic prefix of a first symbol in an uplink zone in an uplink subframe of the received uplink signal for a zone-based automatic gain control scheme.

18. The station as in claim 16, wherein the received signal strength indicator measures a signal strength of the uplink signal received during a first cyclic prefix of a first uplink slot of the uplink zone and each of the preceding uplink slots in the uplink zone, if such preceding slots exist, for a slot-based automatic gain control scheme for the station.

19. A station operating in a mobile Orthogonal Frequency Division Multiple Access (OFDMA) network, comprising:
an antenna receiving an uplink signal;
an analog block converting the received uplink signal into an analog baseband signal;
a received signal strength indicator measuring a signal strength of the received uplink signal and outputting an analog received signal strength indicator;
an analog-to-digital converter (ADC) digitizing the analog received signal strength indicator; and
an automatic gain controller adjusting a power level of the analog baseband signal in accordance with the digitized received signal strength indicator during either a first cyclic prefix in an uplink zone in an uplink subframe of the received uplink signal or a first cyclic prefix in each uplink slot in an uplink zone in an uplink subframe of the received uplink signal.

20. The station as in claim 19, wherein the received signal strength indicator provides a signal strength of the received uplink signal during a cyclic prefix of a first symbol in an uplink zone in an uplink subframe of the received uplink signal, or in an uninterrupted manner, for a zone-based automatic gain control scheme.

21. The station as in claim 19, wherein the received signal strength indicator measures a signal strength of the received uplink signal during a first cyclic prefix of each uplink slot of an uplink zone, or in an uninterrupted manner, for a slot-based automatic gain control scheme for the station.
